(19) United States
(12) Patent Application Publication
(10) Pub. No.: US 2009/0245902 A1
(43) Pub. Date: Oct. 1, 2009

(54) IMAGE FORMING APPARATUS

(75) Inventors: Syoukou Gon, Osaka-shi (JP); Yuzuru Nanjo, Osaka-shi (JP); Akihiro Kondo, Osaka-shi (JP); Eiji Nakajima, Osaka-shi (JP); Naoyuki Ishida, Osaka-shi (JP); Kenichi Kasama, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/393,068

(22) Filed: Feb. 26, 2009

(30) Foreign Application Priority Data
Mar. 28, 2008 (JP) 2008-085378

(51) Int. Cl. G03G 15/20

(52) U.S. Cl. 399/331

(57) ABSTRACT

An image forming apparatus is provided with an image forming station and a fixing unit including a heating member. The fixing unit includes a coil for generating a magnetic field for induction heating the heating member; a first core arranged to face the heating member with the coil located therebetween; a bar-shaped second core including a cut-off portion and arranged in a magnetic path between the first core and the heating member, when seen in a magnetic field generation direction by the coil, to form the magnetic path together with the first core; and a magnetic adjusting mechanism for changing the posture of the second core between a first posture for guiding a magnetic field by retracting the cut-off portion from the magnetic path and a second posture for increasing magnetic resistance by locating the cut-off portion in the magnetic path by rotating the second core about an axis thereof.

### BACKGROUND OF THE INVENTION

1. Field of the Invention

The present invention relates to an image forming apparatus provided with a fixing unit for permitting a sheet bearing a toner image to pass between a heating member and a pressing member to heat and melt unfixed toner and fixe it to the sheet.

2. Description of the Related Art

In recent years, attention has been focused of belt-type image forming apparatuses, in which a smaller heat capacity can be set, due to demands of shortening a warm-up time and saving energy in a fixing unit (see, for example, Japanese Unexamined Patent Publication No. H06-318001). Attention has been also focused on an electromagnetic induction heating method (IH) with a possibility of quick heating and high efficiency heating in recent years, and many products as a combination of electromagnetic induction heating and the employment of a belt have commercialized in light of saving energy upon fixing a color image. In the case of combining the employment of a belt and electromagnetic induction heating, an electromagnetic induction device is often arranged at an outer side of the belt due to merits that a coil can be easily laid out and cooled and further the belt can be directly heated (so-called external IH).

In the above electromagnetic induction heating method, various technologies have been developed to prevent an excessive temperature increase in a sheet non-passage area in consideration of a sheet width (paper width) passed through the fixing unit. Particularly, the following prior arts are known as size switching means in the external IH.

A first prior art (Japanese Unexamined Patent Publication No. 2003-107941) discloses that a magnetic member is divided into a plurality of pieces, which are arranged in a sheet width direction, and some of the magnetic member pieces are moved toward or away from an exciting coil in accordance with the size of a sheet to be passed (paper width). In this case, heating efficiency decreases by moving the magnetic member pieces away from the exciting coil in sheet non-passage areas, and the amount of heat generation is thought to be less than in an area corresponding to a sheet with a minimum paper width.

A second prior art (Publication of Japanese Patent No. 3527442) discloses that other conductive members are arranged outside a minimum paper width in a heating roller and the positions thereof are switched between those inside and outside the extent of a magnetic field. According to the second prior art, the conductive members are first located outside the extent of the magnetic field to heat the heating roller by electromagnetic induction. If the temperature of the heating roller rises to the vicinity of a Curie temperature, the conductive members are moved to the extent of the magnetic field. Then, magnetic flux leaks from the heating roller from the outer sides of the minimum paper width, thereby preventing excessive temperature increases in the sheet non-passage areas.

However, the first prior art has a problem of inadvertently enlarging the entire apparatus since the movable range of the magnetic member is large and an extra space is, accordingly necessary. On the other hand, the second prior art can save space since the members for switching the size are arranged in the heating roller. However, the interior of the heating roller is a high-temperature environment and it is necessary to set a high Curie temperature in the case of arranging a certain member therein. Above all, a member with large heat capacity has a problem of extending a warm-up time.

### SUMMARY OF THE INVENTION

An object of the present invention is to provide an image forming apparatus capable of promoting lower heat capacity, reducing a warm-up time and realizing space saving by reducing the number of members arranged in a heating member.

In order to accomplish this object, one aspect of the present invention is directed to an image forming apparatus, comprising an image forming station for transferring a toner image to a sheet; and a fixing unit including a heating member and a pressing member and adapted to convey the sheet while sandwiching the sheet between the heating member and the pressing member and to fix the toner image to the sheet, wherein the fixing unit includes a coil arranged along an outer surface of the heating member for generating a magnetic field; a first core fixedly arranged to face the heating member with the coil located therebetween; a second core which is a bar-shaped body extending along an axial line in a direction orthogonal to a conveying direction of the sheet and formed with a partial cut-off portion when seen in a cross section in an axial direction, is arranged in a magnetic path between the first core and the heating member, when seen in a magnetic field generation direction by the coil, and can change a posture thereof; and a magnetic adjusting mechanism for changing the posture of the second core between a first posture for guiding a magnetic field by retracting the cut-off portion from the magnetic path and a second posture for increasing magnetic resistance by locating the cut-off portion in the magnetic path by rotating the second core about an axial line thereof.

### BRIEF DESCRIPTION OF THE DRAWINGS

FIG. 1 is a schematic diagram showing the construction of an image forming apparatus according to one embodiment of the invention,

FIG. 2 is a vertical section showing the structure of a fixing unit according to the embodiment of the invention,

FIG. 3 is a plan view showing the detailed entire construction of a center core,

FIGS. 4A and 4B are side views respectively showing operation examples according to the rotation of the center core,

FIG. 5A is a section along VA-VA of FIG. 4A and FIG. 5B is a section along VB-VB of FIG. 4B,

FIG. 6 is a diagram showing another structure example of a fixing unit, and

FIG. 7 is a diagram showing another structure example of an IH coil unit.

### DETAILED DESCRIPTION OF THE PREFERRED EMBODIMENTS

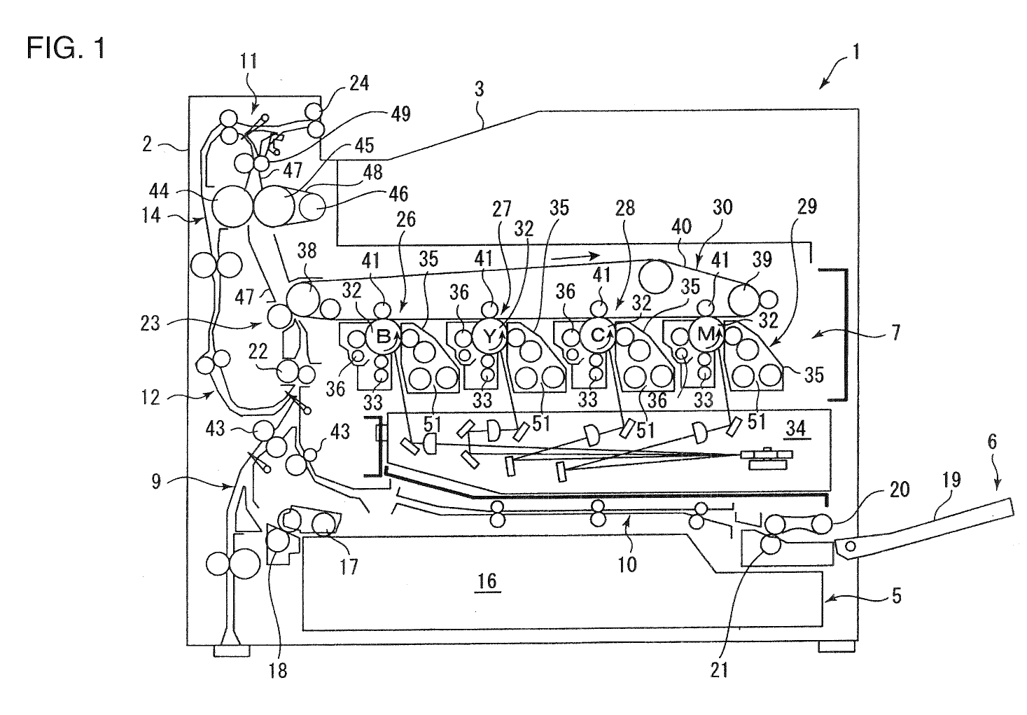

FIG. 1 is a schematic diagram showing the construction of an image forming apparatus 1 according to one embodiment of the present invention. The image forming apparatus 1 can be a printer, a copier, a facsimile machine, a complex machine of these functions or the like for printing by transferring a toner image to the surface of a print medium such as a print sheet, for example, in accordance with externally inputted image information.

The image forming apparatus 1 shown in FIG. 1 is a tandem color printer. This image forming apparatus 1 is provided with an apparatus main body 2 in the form of a rectangular box for forming (printing) a color image on a sheet inside. A sheet discharge unit (discharge tray) 3 for discharging a sheet having a color image printed thereon is provided in a top part of the apparatus main body 2.

A sheet cassette 5 for storing sheets is arranged at the bottom in the interior of the apparatus main body 2, a stack tray 6 for manually feeding a sheet is arranged in an intermediate part, and an image forming station 7 is arranged in an upper part. The image forming station 7 forms (transfers) a toner image on a sheet based on image data such as characters and pictures transmitted from the outside of the apparatus.

A first conveyance path 9 for conveying a sheet dispensed from the sheet cassette 5 to the image forming station 7 is arranged in a left part of the apparatus main body 2 in FIG. 1, and a second conveyance path 10 for conveying a sheet dispensed from the stack tray 6 to the image forming station 7 is arranged from a right side to the left side. Further, a fixing unit 14 for performing a fixing process to a sheet having an image formed thereon in the image forming station 7 and a third conveyance path 11 for conveying the sheet finished with the fixing process to the sheet discharging unit 3 are arranged in a left upper part in the apparatus main body 2.

The sheet cassette 5 enables the replenishment of sheets by being withdrawn toward the outside (e.g. toward front side in FIG. 1) of the apparatus main body 2. This sheet cassette 5 includes a storing portion 16, which can selectively store at least two types of sheets having different sizes in a sheet feeding direction. Sheets stored in the storing portion 16 are dispensed one by one toward the first conveyance path 9 by a feed roller 17 and separation rollers 18.

The stack tray 6 can be opened and closed relative to an outer surface of the apparatus main body 2, and sheets to be manually fed are placed one by one or a plurality of sheets are placed on a manual feeding portion 19. Sheets placed on the manual feeding portion 19 are dispensed one by one toward the second conveyance path 10 by a pickup roller 20 and separation rollers 21.

The first conveyance path 9 and the second conveyance path 10 join before registration rollers 22. A sheet fed to the registration rollers 22 temporarily waits on standby here and is conveyed toward a secondary transfer unit 23 after a skew adjustment and a timing adjustment. A full color toner image on an intermediate transfer belt 40 is secondarily transferred to the conveyed sheet in the secondary transfer unit 23. Thereafter, the sheet having the toner image fixed in the fixing unit 14 is reversed in a fourth conveyance path 12 if necessary, so that a full color toner image is secondarily transferred also to the opposite side of the sheet in the secondary transfer unit 23. After the toner image on the opposite side is fixed in the fixing unit 14, the sheet is discharged to the sheet discharging unit 3 by discharge rollers 24 through the third conveyance path 11.

The image forming station 7 includes four image forming units 26, 27, 28 and 29 for forming toner images of black (B), yellow (Y), cyan (C) and magenta (M) and an intermediate transfer unit 30 for bearing the toner images of the respective colors formed in the image forming units 26 to 29 in a superimposed manner.

Each of the image forming units 26 to 29 includes a photoconductive drum 32, a charger 33 arranged to face the circumferential surface of the photosensitive drum 32, a laser scanning unit 34 arranged downstream of the charger 33 for emitting a laser beam to a specific position on the circumferential surface of the photosensitive drum 32, a developing device 35 arranged to face the circumferential surface of the photosensitive drum 32 downstream of a laser beam emission position from the laser scanning unit 34 and a cleaning device 36 arranged downstream of the developing device 35 to face the photosensitive drum 32.

The photosensitive drum 32 of each of the image forming units 26 to 29 is rotated in a counterclockwise direction of FIG. 1 by an unillustrated drive motor. Black toner, yellow toner, cyan toner and magenta toner are respectively contained in toner boxes 51 of the developing devices 35 of the respective image forming units 26 to 29.

The image transfer unit 30 includes a drive roller 38 arranged at a position near the image forming unit 26, a driven roller 39 arranged at a position near the image forming unit 29, an intermediate transfer belt 40 mounted on the drive roller 38 and the driven roller 39 and four transfer rollers 41 arranged in correspondence with the photosensitive drums 32 of the respective image forming units 26 to 29. The respective transfer rollers 41 are arranged at positions downstream of the developing devices 35 of the corresponding image forming units 26 to 29 such that they can be pressed into contact with the photosensitive drum 32 via the intermediate transfer belt 40.

In this image transfer unit 30, the toner images of the respective colors are transferred in a superimposition manner on the intermediate transfer belt 40 at the positions of the transfer rollers 41 of the respective image forming units 26 to 29. As a result, a full color toner image is finally formed on the intermediate transfer belt 40.

The first conveyance path 9 conveys a sheet dispensed from the sheet cassette 5 toward the image transfer unit 30. The first conveyance path 9 includes a plurality of conveyor rollers 43 arranged at specified positions in the apparatus main body 2 and the registration rollers 22 arranged before the image transfer unit 30 for timing an image forming operation and a sheet feeding operation in the image forming station 7.

The fixing unit 14 fixes an unfixed toner image to a sheet by heating and pressing the sheet having the toner image transferred thereto in the image forming station 7. The fixing unit 14 includes a pair of rollers comprised of a heating pressure roller 44 (pressing member) and a fixing roller 45. The pressure roller 44 is a metallic roller, and the fixing roller 45 is comprised of a metallic core material, an outer layer (e.g. silicon sponge) made of elastic material and a mold releasing layer (e.g. PFA). Further, a heat roller 46 is disposed adjacent to the fixing roller 45, and a heating belt 48 (heating member) is mounted on this heat roller 46 and the fixing roller 45. A detailed structure of the fixing unit 14 is described later.

Conveyance paths 47 are arranged upstream and downstream of the fixing unit 14 in a sheet conveying direction. A sheet conveyed through the image transfer unit 30 is introduced to a nip between the pressure roller 44 and the fixing roller 45 (heating belt 48) via the upstream conveyance path 47. The sheet having passed between the pressure roller 44 and the fixing roller 45 is guided to the third conveyance path 11 via the downstream conveyance path 47.

The third conveyance path 11 conveys the sheet finished with the fixing process in the fixing unit 14 to the sheet discharging unit 3. Thus, conveyer rollers 49 are arranged at a suitable position in the third conveyance path 11 and the above discharge rollers 24 are arranged at the exit of the third conveyance path 11.

### <Details of the Fixing Unit>

Next, the fixing unit 14 according to the embodiment employed in the above image forming apparatus 1 is described in detail.

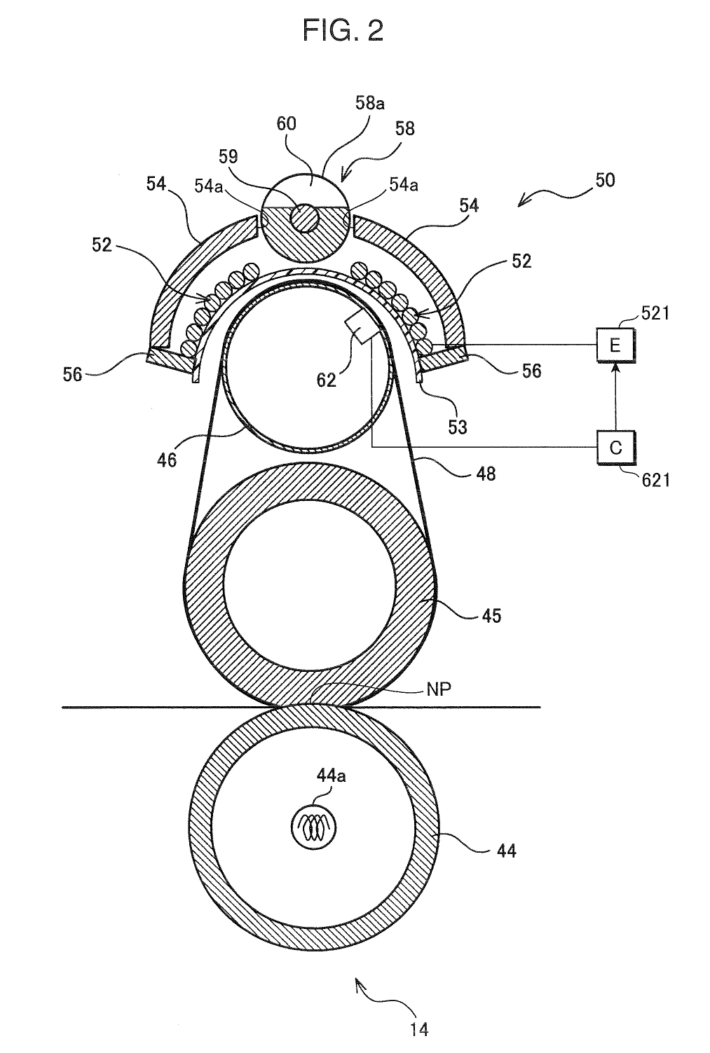

FIG. 2 is a vertical section showing the structure of the fixing unit 14 of the first embodiment. In a state shown in FIG. 2, the orientation of the fixing unit 14 is rotated counterclockwise by about 90° from an actually mounted state in the image forming apparatus 1. Accordingly, the sheet conveying direction from lower side to upper side in FIG. 1 is from right side to left side in FIG. 2. If the apparatus main body 2 has a larger size (complex machine or the like), the fixing unit 14 may be actually mounted in the orientation shown in FIG. 2.

The fixing unit 14 includes the pressure roller 44, the fixing roller 45, the heat roller 46 and the heating belt 48 as described above. Since an elastic layer made of silicon sponge is formed on the outer surface of the fixing roller 45 as described above, a flat nip NP is formed between the heating belt 48 and the fixing roller 45.

A base member of the heating belt 48 is made of a ferromagnetic material (e.g. Ni), a thin elastic layer (e.g. silicon rubber) is formed on the outer surface of the base member, and a mold releasing layer (e.g. PFA) is formed on the outer surface of the elastic layer. The heating belt 48 may be a resin belt made of, e.g. PI in the case of being provided with no heat generating mechanism. A core of the heat roller 46 is made of a magnetic metal (e.g. Fe, SUS) and a mold releasing layer (e.g. PFA) is formed on the outer surface of the core.

Specifically, a core of the pressure roller 44 is made of Fe, Al or the like, a Si-rubber layer is formed on this core, and a fluororesin layer is formed on the outer surface of the Si-rubber layer. For example, a halogen heater 44a is disposed inside the pressure roller 44.

In addition, the fixing unit 14 includes an IH coil unit 50 (not shown in FIG. 1) outside the heat roller 46 and the heating belt 48. The IH coil unit 50 includes an induction heating coil 52, pairs of arch cores 54 (part of a first core), a pair of side cores 56 (part of the first core) and a center core 58 (second core).

### [Coil]

As shown in FIG. 2, the induction heating coil 52 is arranged on a virtual arcuate surface extending along an arcuate outer surface of the heating belt 48 for induction heating in arcuate parts of the heat roller 46 and the heating belt 48. The induction heating coil 52 generates a magnetic field for induction heating the heat roller 46 and the heating belt 48 over an area (first area) on the heating belt 48 held in contact with a maximum sheet when the maximum one of sheets conveyable by the fixing unit 14 passes.

Actually, a bobbin 53 made of a resin is, for example, arranged outside the heat roller 46 and the heating belt 48, and the induction heating coil 52 is arranged in a wound manner on this bobbin 53. The bobbin 53 is formed to have a semicylindrical shape extending along the outer surface of the heat roller 46. The bobbin 53 is preferably made of a heat resistant resin (e.g. PPS, PET, LCP).

### [First Core/Fixed Core]

The center core 58 is located in the center in FIG. 2, and the arch cores 54 and the side cores 56 are arranged in pairs at the opposite sides of the center core 58. The arch cores 54 at the opposite sides are cores made of ferrite and formed to have arched cross sections symmetrical with each other, and the entire lengths thereof are longer than a winding area of the induction heating coil 52. The side cores 56 at the opposite sides are cores made of ferrite and having a block shape. The side cores 56 at the opposite sides are connected with one ends (bottom ends in FIG. 2) of the corresponding arch cores 54 and cover the outer side of the wining area of the induction heating coil 52.

The arch cores 54 are fixed at a plurality of positions spaced apart in a longitudinal direction of the heat roller 46. The side cores 56 are continuously fixed without being interrupted in the longitudinal direction of the heat roller 46, and the entire length thereof corresponds to the length of a winding area of the induction heating coil 52. The arrangement of these cores 54, 56 is determined, for example, in conformity with a magnetic flux density (magnetic field intensity) distribution of the induction heating coil 52. Since the arch cores 54 are arranged at certain intervals, the side cores 56 compensate for a magnetic field converging effect at interrupted positions to level the magnetic flux density distribution (temperature difference) in the longitudinal direction. For example, an unillustrated core holder made of a resin is provided outside the arch cores 54 and the side cores 56. The arch cores 54 and the side cores 56 are supported by this core holder. The core holder is also preferably made of a heat resistant resin (e.g. PPS, PET, LCP).

### [Second Core/Movable Core]

The center core 58 is a core made of ferrite and having the shape of a single bar as a whole. A rotary shaft member 59 is inserted in the center of the center core 58 along an axial direction (longitudinal direction). This rotary shaft member 59 is made, for example, a nonmagnetic metal (AL or the like) or a heat resistant resin (PPS, PET, LCP or the like). Although only a section at one position is shown in FIG. 2, the center core 58 is comprised of parts having a substantially half-moon shaped cross section and parts having a substantially circular (ring shaped in this embodiment) cross section when viewed in the axial direction.

The center core 58 is arranged near the heat roller 46 and one ends of the arch cores 54. Specifically, the center core 58 is arranged between the arch cores 54 and the heating roller 46 (heating belt 48), when seen in a generation direction of a magnetic field by the induction heating coil 52, in order to form magnetic paths together with the arch cores 54 and the side cores 56. More specifically, ends 54a (entrances or exits of the magnetic paths) of the arch cores 54 are distant from the heating belt 48, but the center core 58 is a member for forming intermediate magnetic paths between the ends 54a and the heating belt 48. A specific construction of the center core 58 is further described later.

### [Cut-Off Portions]

Cut-off portions 60 are formed by partially cutting off the center core 58 along the axial direction at the above parts of the center core 58 having the substantially half-moon shaped cross section. The cut-off portions 60 are arranged at the opposite ends of the center core 58 in the axial direction. The cut-off portions 60 may be simultaneously formed by a molding die at the time of sintering ferrite powder or may be formed by forming a solid or hollow cylindrical shape and then cutting it (any forming method can be employed as long as the cut-off portions have the substantially half-moon shaped cross section in a final shape).

### [Temperature Controller]

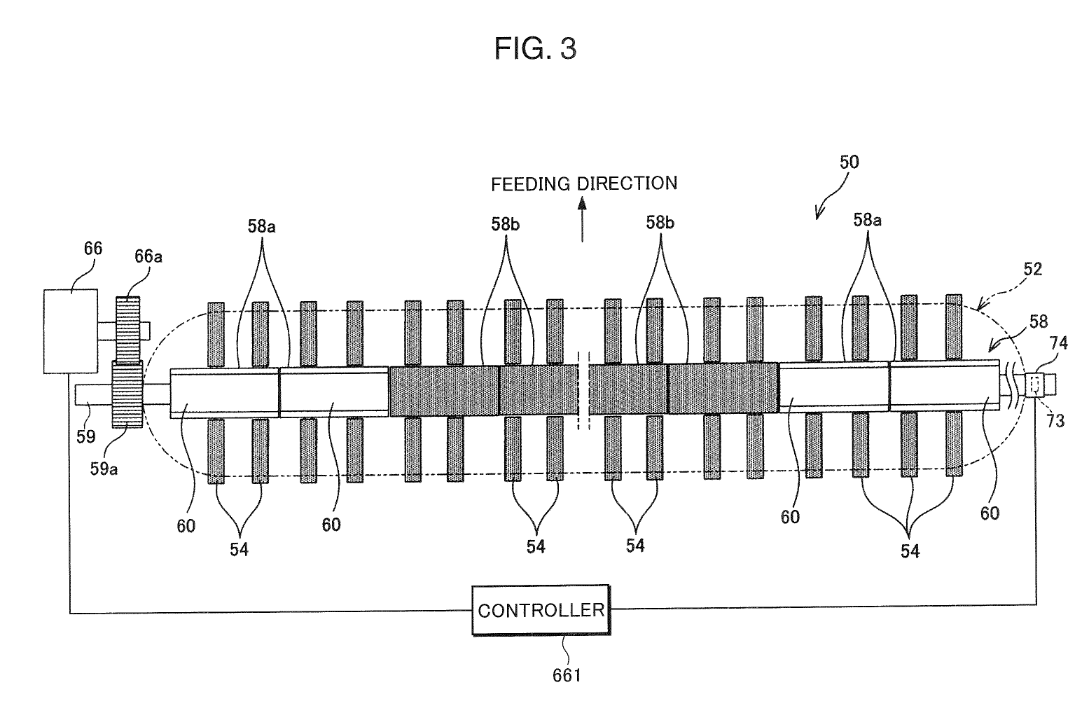

In the example of FIG. 2, a temperature controller includes a thermistor 62 (temperature responding element) and a temperature control circuit 621. The thermistor 62 is disposed inside the heat roller 46 to detect the temperature of the heat roller 46. One or more thermistors 62 can be disposed at positions in the heating roller 46 where the amount of heat generation by induction heating is particularly large. In the construction of the first embodiment, the thermistor 62 is desirably disposed at an inner side facing a longitudinal central position (in a later-described area of a minimum paper width W1 shown in FIG. 3) of the heating roller 46.

The temperature control circuit 621 provided in the image forming apparatus 1 controls a power supply device 521 of alternating current power supplied to the induction heating coil 52 based on the temperature detected by the thermistor 62. The temperature control circuit 621 controls the alternating current power supplied from the power supply device 521 to the induction heating coil 52 such that a temperature T detected by the thermistor 62 is maintained at a target temperature Ta necessary to fix a toner image to a sheet. This control may be performed by on-off controlling the power supply device 521. Alternatively, a control to be executed may be such that the amount of alternating current power supplied to the induction heating coil 52 is increased and decreased by changing the voltage and/or frequency of the alternating current power generated by the power supply device 521.

One or more thermostats (temperature responding elements) may be disposed inside the heating roller 46. The thermostat can be disposed at positions in the heating roller 46 where the amount of heat generation by induction heating is particularly large and operate in response to an excessive temperature increase of the heating roller 46 to stop the heating by the induction heating coil 52.

### [Magnetic Adjusting Mechanism]

If the cut-off portions 60 are located at positions (retracted positions: first posture) most distant from the heating belt 48 as shown in FIG. 2, magnetic resistance decreases around the induction heating coil 52. Accordingly, magnetic paths are formed via the arch cores 54 and the side cores 56 at the opposite sides with the center core 58 as a center, whereby a magnetic field acts on the heating belt 48 and the heat roller 46.

On the other hand, if the center core 58 is rotated by 180° (direction is not particularly limited) from the state shown in FIG. 2 to move the cut-off portions 60 to positions (resistance positions; second posture) where the cut-off portions 60 are close to the outer surface of the heating belt 48, the magnetic resistance increases around the induction heating coil 52 to reduce a magnetic field intensity. Magnetic adjustments by the switching of the cut-off portions 60 are further described later.

### [Details of the Center Core]

FIG. 3 is a plan view showing the overall construction of the center core 58 in detail. The center core 58 extends in a sheet width direction orthogonal to a feeding direction (direction of an arrow in FIG. 3), and the entire length thereof is slightly larger than a maximum paper width (first area on the heating belt 48 to be held in contact with a maximum one of sheets conveyable by the fixing unit 14 when this sheet passes: e.g. A3 vertical, A4 horizontal). Although the center core 58 is in the form of a single bar as a whole, it is made up of a plurality of end block-shaped cores 58a (second blocks) and a plurality of middle block-shaped cores 58b (first blocks).

Here is shown an example in which, assuming that the length of the respective block-shaped cores 58a, 58b in the axial direction is, for example, about 30 mm, seven middle block-shaped cores 58b (all of them are not shown in FIG. 3) are arranged in a central area of the center core 58 in the axial direction and two end block-shaped cores 58a are arranged in each of areas at the opposite end positions, i.e. a total of four end block-shaped cores 58a are arranged. Out of these block-shaped cores, any of the total of seven middle block-shaped cores 58b located at middle positions has a substantially circular cross section in a direction orthogonal to an axial line. In other words, these middle block-shaped cores 58b are not formed with the cut-off portions 60. On the other hand, the total of four end block-shaped cores 58a at the opposite end positions are formed with the cut-off portions 60 and, hence, have the substantially half-moon shaped cross section in the direction orthogonal to the axial line. The surfaces of the middle block-shaped cores 58b having the substantially circular cross section are shown by halftone and the end block-shaped cores 58a having the substantially half-moon shaped cross section are not specially shown by halftone for easier discrimination in FIG. 3.

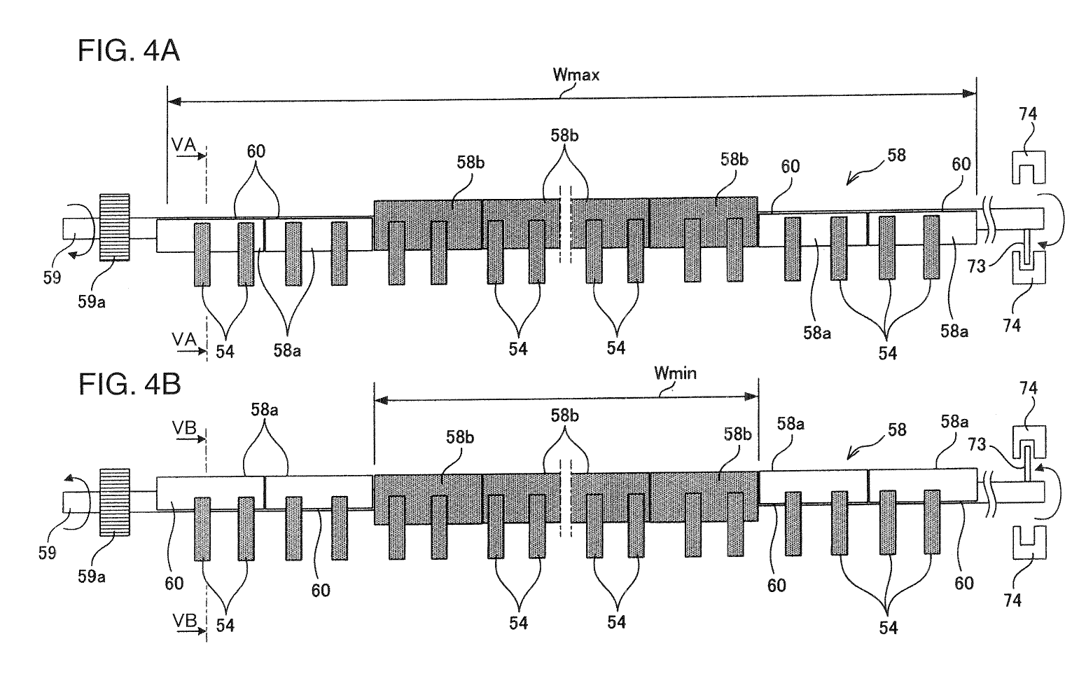

With reference to FIGS. 4A and 4B, the length of the center core 58 in the axial direction is set to be slightly longer than a maximum paper width Wmax. On the other hand, a part where the seven middle block-shaped cores 58b are arranged corresponds to a minimum paper width Wmin (second area on the heating belt 48 to be held in contact with a minimum one of sheets conveyable by the fixing unit 14 when this sheet passes). The end block-shaped cores 58a are arranged in areas outside this area of the minimum paper width Wmin.

As described above, the rotary shaft member 59 entirely penetrates through the center core 58 in the axial direction and the entire length thereof is longer than that of the center core 58. The respective block-shaped cores 58a, 58b are bonded to the outer circumferential surface of the rotary shaft member 59. Thus, the block-shaped cores 58a, 58b rotate together as the rotary shaft member 59 rotates.

### [Driving Mechanism]

The IH coil unit 50 is equipped with another drive motor 66, and the rotary shaft member 59 can be rotated by a torque of this drive motor 66. A driven gear 59a is mounted on one end of the rotary shaft member 59, and an output gear 66a of the drive motor 66 is engaged with this driven gear 59a. When the drive motor 66 is driven, the rotary shaft member 59 is rotated by its torque, whereby the center core 58 (all the block-shaped cores 58a, 58b) can be integrally rotated.

### [Control Method]

This embodiment is provided with a rotation controller 661, a position detecting member 73 radially projecting at the other end of the rotary shaft member 59 and two photointerrupters 74 arranged above and below in conformity with the disposed position of the position detecting member 73. FIGS. 4A and 4B are side views showing operation examples according to the rotation of the center core 58. The respective operation examples are described below.

The rotation controller 661 rotates the entire center core 58 about the axial line by controlling the operation of the drive motor 66. A stop position of the drive motor 66 is controlled in accordance with detection signals from the photointerrupters 74. Specifically, the rotation controller 661 rotates the center core 58 by 180° about the axial line each time to switch the positions (orientations) of the cut-off portions 60 between the retracted positions and the resistance positions.

FIG. 4A shows a state where the cut-off portions 60 are switched to the retracted positions. In the state switched to the retracted positions, the cut-off portions 60 are kept stationary at positions most distant from the heat roller 46 and the heating belt 48. In this case, the entire center core 58 can permit a magnetic field to satisfactorily pass in a range of the maximum paper width Wmax.

FIG. 4B shows a state where the cut-off portions 60 are switched to the resistance positions. The resistance positions and the above retracted positions are equivalent to opposite positions attained by being rotated by 180° from each other. For example, if the state where the cut-off portions 60 are switched to the retracted positions is a reference state, the rotation controller 661 drives the drive motor 66 to rotate the rotary shaft member 59 in one direction and stops the drive motor 66 when obtaining a signal indicating that one photointerrupter 74 (upper one in FIGS. 4) detected the position detecting member 73 in the case of switching the cut-off portions 60 to the resistance positions from the reference state.

In the case of returning the cut-off portions 60 to the retracted positions, the rotation controller 661 drives the drive motor 66 to rotate the rotary shaft member 59 and stops the drive motor 66 when obtaining a signal indicating that the other photointerrupter 74 (lower one in FIGS. 4) detected the position detecting member 73. In the state switched to the resistance positions, the cut-off portions 60 are located at positions closest to the heat roller 46 and the heating belt 48. In this case, the entire center core 58 permits the magnetic field to satisfactorily pass in a range of the minimum paper width Wmin, but the magnetic field intensity decreases in outer ranges.

A stepping motor can be, for example, used as the drive motor 66. In this case, the rotation controller 661 includes a control circuit for generating a drive pulse for controlling this motor. This control circuit is, for example, constructed by a control IC, input and output drivers, a semiconductor memory and the like.

The detection signals from the respective photointerrupters 74 are inputted to the control IC of the rotation controller 661 via the input driver, and the control IC detects a present rotation angle (position) of the drive motor 66 based on these. On the other hand, information concerning the present sheet size is notified to the control IC from an unillustrated image formation controller. Upon receiving this information, the control IC reads the position information (resistance positions or retracted positions) of the cut-off portions 60 suitable for the sheet size from the semiconductor memory (ROM) and outputs drive pulses corresponding to the rotation angle (180°) equivalent to the position information at that time. The drive pulses are applied to the drive motor 66 via the output driver and the drive motor 66 operates upon receiving them.

Although two photointerrupters 74 are used here, the state where the cut-off portions 60 are located at the retracted positions may be set as a reference position and only one photointerrupter 74 may be arranged at such a position that the position detecting member 73 is detected in this state. In this case, the stop position of the drive motor 66 can be controlled by setting positions attained by rotating the rotary shaft member 59 by 180° from the reference position (retracted positions) as the resistance positions.

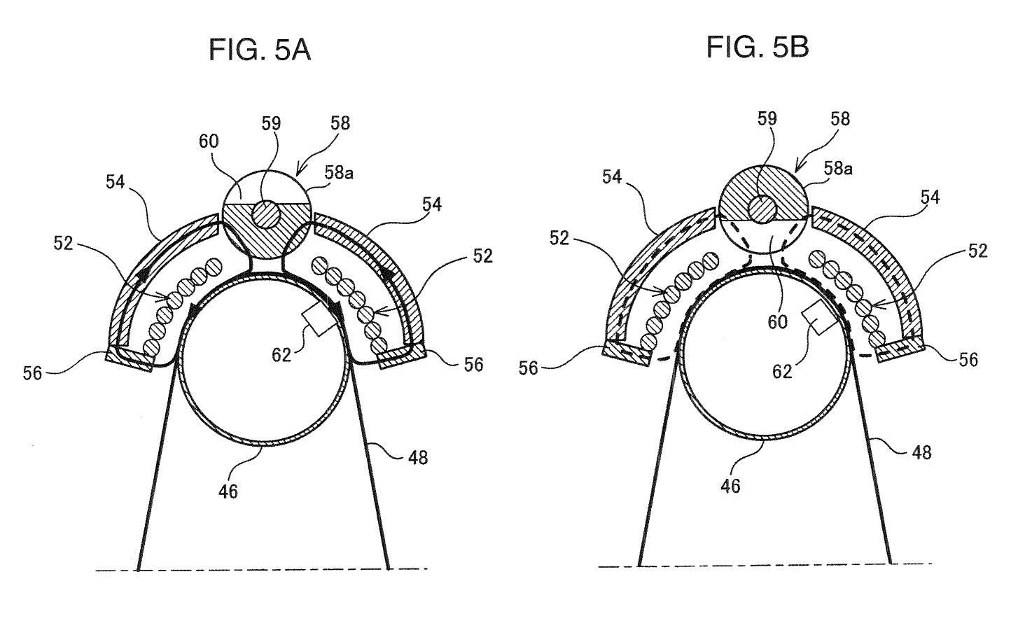

FIG. 5A is a section along VA-VA of FIG. 4A and FIG. 5B is a section along VB-VB of FIG. 4B. As shown in FIG. 5A, the cut-off portions 60 are not present in the magnetic paths (shown by solid-line arrows in FIG. 5A) in the case of switching the cut-off portions 60 to the retracted positions. Thus, the end block-shaped cores 58a located at the opposite ends of the center core 58 in the axial direction can satisfactorily guide the magnetic field via their parts having the substantially half-moon shaped cross section. In this state, the magnetic field generated by the induction heating coil 52 passes through the heating belt 48 and the heat roller 46 via the side cores 56, the arch cores 54 and the entire center core 58 (block-shaped cores 58a, 58b). At this time, eddy currents are generated in the heating belt 48 and the heat roller 46, which are ferromagnetic bodies, and Joule heat is generated for heating by specific resistances of the respective materials.

On the other hand, in the case of switching the cut-off portions 60 to the resistance positions as shown in FIG. 5B, the cut-off portions 60 are located in the magnetic paths at the opposite end positions of the center core 58 in the axial direction. Thus, the generation of the magnetic field is partially suppressed there to increase magnetic resistance. In this way, amounts of heat generated at the opposite outer sides of the minimum paper width are suppressed, whereby excessive temperature increases of the heating belt 48 and the heat roller 46 can be prevented.

### [Other Structure Example]

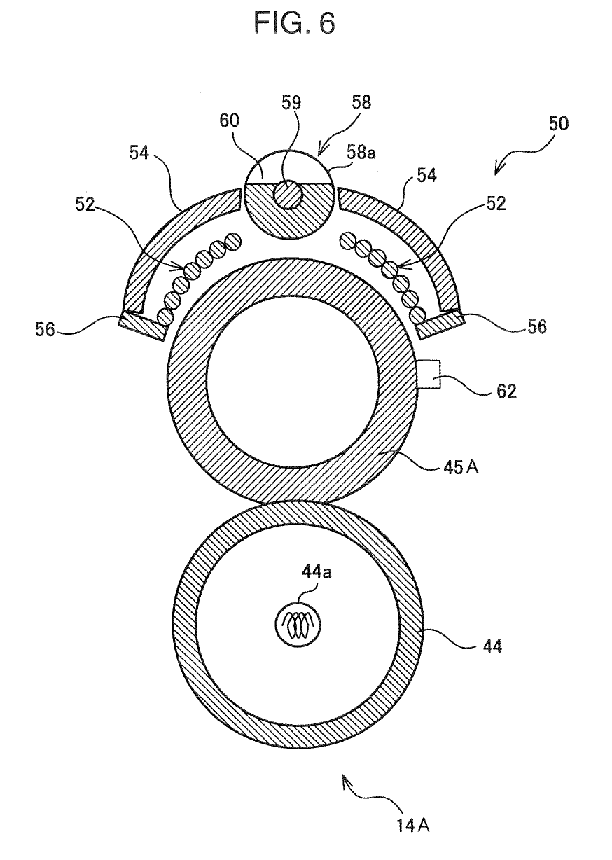

FIG. 6 is a diagram showing a fixing unit 14A according to another structure example of the above fixing unit 14. In this structure example, a toner image is fixed by a fixing roller 45A and a pressure roller 44 without using the above heating belt. An IH coil unit 50 is arranged to face a circumferential surface of this fixing roller 45A.

A magnetic body similar to the above heating belt is, for example, wound around the outer circumferential surface of the fixing roller 45A, and the magnetic body is induction heated by the induction heating coil 52. In this case, a thermistor 62 is disposed at a position facing a magnetic body layer outside the fixing roller 45A. The others are the same as above and a change of the sheet size can be dealt with by rotating the entire center core 58 together with the rotary shaft member 59.

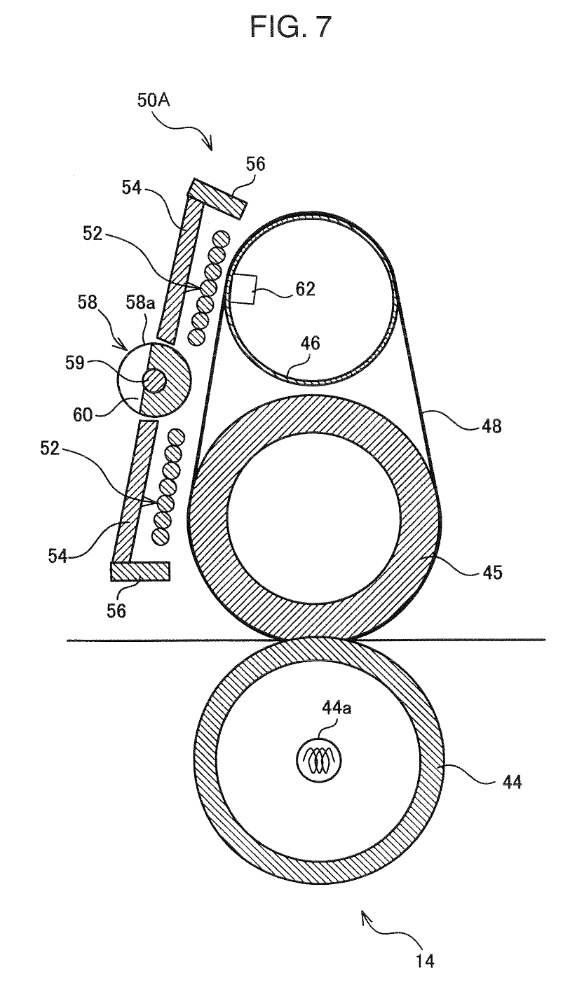

Next, FIG. 7 is a diagram showing an IH coil unit 50A according to another structure example. In this structure example, induction heating is performed not at a position facing the arcuate part of the heating belt 48, but at a position facing a flat part of the heating belt 48 between the heat roller 46 and the fixing roller 45. In this case as well, a change of the sheet size can be dealt with by rotating the entire center core 58 together with the rotary shaft member 59.

The present invention can be variously modified without being limited to the above embodiments. Although the entire center core 58 is made up of a plurality of block-shaped cores 58a, 58b in one embodiment, it may be integrally formed and cut-off portions 60 may be formed at the opposite end positions. Alternatively, the entire center core 58 may have a solid structure (no through hole is present in the axial direction) and rotary shaft members 59 may be fixed only at the opposite ends of the center core 58. The cross section in this case is circular in a central area while being half-moon shaped in opposite end areas.

The cross sectional shape of the middle block-shaped cores 58b is not limited to the substantially circular one and may be polygonal. Further, the substantially half-moon shaped parts of the end block-shaped cores 58a may have a polygonal shape and the size and the shape of the cut-off portions 60 are not particularly limited to the shown example. The length of the respective block-shaped cores 58a, 58b is not particularly limited and can be suitably set in accordance with sheet sizes to be used. Besides, the specific forms of the respective parts including the arch cores 54 and the side cores 56 are not limited to the shown ones and can be suitably modified.

The above specific embodiments mainly embrace inventions having the following constructions.

An image forming apparatus according to one aspect of the present invention comprises an image forming station for transferring a toner image to a sheet; and a fixing unit including a heating member and a pressing member and adapted to convey the sheet while sandwiching the sheet between the heating member and the pressing member and to fix the toner image to the sheet, wherein the fixing unit includes a coil arranged along an outer surface of the heating member for generating a magnetic field; a first core fixedly arranged to face the heating member with the coil located therebetween; a second core which is a bar-shaped body extending along an axial line in a direction orthogonal to a conveying direction of the sheet and formed with a partial cut-off portion when seen in a cross section in an axial direction, is arranged in a magnetic path between the first core and the heating member, when seen in a magnetic field generation direction by the coil, and can change a posture thereof; and a magnetic adjusting mechanism for changing the posture of the second core between a first posture for guiding a magnetic field by retracting the cut-off portion from the magnetic path and a second posture for increasing magnetic resistance by locating the cut-off portion in the magnetic path by rotating the second core about an axial line thereof.

According to this construction, it is not necessary to provide a special member inside the heating member since a method for heating and melting the toner image by induction heating the heating member by the magnetic field generated by the coil of the fixing unit (external IH) is employed. Further, since the first core is arranged around the coil to form the magnetic path for guiding the magnetic field generated by the coil and the second core is merely arranged between the first core and the heating member, there is no likelihood of inadvertently increasing a space to be occupied as a whole.

Particularly in the above construction, an amount of heat generated by the heating member can be adjusted only by rotating the movable core about the axial line. In other words, when the magnetic adjusting mechanism rotates the second core to switch the cut-off portion to a retracted position, the magnetic field generated by the coil is guided by the first and second cores to generate an eddy current in the heating member for magnetic induction heating. On the other hand, when the magnetic adjusting mechanism rotates the second core to switch the cut-off portion to a resistance position, the magnetic resistance in the magnetic path increases (a part of the magnetic path is replaced by an air gap) to reduce magnetic field intensity, whereby the amount of heat generated by the heating member can be reduced.

In this way, it is not necessary to distance the cores from the heating member upon adjusting the amount of heat generated by the heating member and space saving can be promoted by that much in the present invention. Further, since it is not necessary to provide cores for magnetic induction and an electrically conductive member for magnetic field adjustment inside the heating member, contribution can be made to a reduction of warm-up time by suppressing an increase of heat capacity.

In the above construction, the coil generates the magnetic field for induction heating the heating member at least over a first area on the heating member to be held in contact with a maximum one of sheets conveyable by the fixing unit when this sheet passes, and the cut-off portion of the second core is arranged at a position corresponding to each of the opposite end positions of the first area. According to this construction, the amount of heat generated by the heating member can be adjusted in accordance with a size of a sheet passing the fixing unit.

In this case, the cut-off portions of the second core are preferably substantially arranged at positions outside a second area to be held in contact with a minimum one of sheets conveyable by the fixing unit when this sheet passes. According to this construction, at least the second area of the heating member where minimum sheets pass is constantly heated and heating can be suitably restricted in areas other than this.

In the above construction, it is preferable that the second core is formed such that a central part thereof located in the center when viewed in the axial direction has a substantially circular cross section over a range corresponding to a specified sheet width and the cut-off portions located at the opposite sides of the central part have a substantially half-moon shaped cross section obtained by partly cutting off a circular shape; and that the orientations of the cut-off portions having the substantially half-moon shaped cross section change according to the rotation of the second core about the axial line.

According to such a mode, the cut-off portion is not formed in the entire second core, but the cut-off portions are formed only in the opposite end parts having the substantially half-moon shaped cross section and no cut-off portion is formed in the central part corresponding to the specified sheet width. Thus, even if the second core is rotated, the magnetic field is constantly satisfactorily guided to efficiently induction heat the heating member in a range of the specified sheet width, whereby the warm-up time can be shortened. Further, if a sheet size is large, the cut-off portions are switched to the retracted positions by changing the orientations of the opposite side parts (substantially half-moon shaped parts), whereby the magnetic field can be satisfactorily guided over the entire area of the second core in the axial direction and the heating member can be induction heated in a range corresponding to a maximum sheet width. On the other hand, if the sheet size is changed to a specified width, the orientations of the opposite side parts are changed to switch the cut-off portions to the resistance positions, whereby excessive temperature increases of the heating member in ranges where no paper is passed can be prevented.

In the above construction, it is preferable that a rotary shaft member for supporting the second core is further provided; and that the second core includes a substantially circular first block and substantially half-moon shaped second blocks and is bonded to the outer circumferential surface of the rotary shaft member. According to this construction, the second core can be formed only by bonding the first and second blocks to the rotary shaft member and a structure for rotating the second core can be simplified.

In this case, either one or both of the first and second blocks are made up of smaller blocks. According to this construction, convenience in manufacturing the second core can be further improved.

In the above construction, the magnetic adjusting mechanism preferably includes a motor for rotating the rotary shaft member. According to this construction, the magnetic adjusting mechanism can be easily built.

In the above construction, it is preferable that the heating member includes an arcuate part; that the first core includes an arch core having an arcuate shape; and that the second core is arranged near the arcuate part of the heating member and one end of the arch core. According to this construction, the second core can be arranged in the magnetic path while taking up only a small space.

As described above, according to the image forming apparatus of the present invention, no mechanism for magnetic shielding needs to be provided in the heating member and, accordingly, heat capacity can be reduced. Thus, the shortening of the warm-up time of the fixing unit can be realized. Even in the external IH, only the movable core is rotated, wherefore a movable range can be made smaller as a whole and the fixing unit, consequently the entire image forming apparatus can be miniaturized by that much.

This application is based on Japanese Patent Application No. 2008-085378 filed on Mar. 28, 2008 respectively, the contents of which are hereby incorporated by reference.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An image forming apparatus, comprising:
an image forming station for transferring a toner image to a sheet; and
a fixing unit including a heating member and a pressing member and adapted to convey the sheet while sandwiching the sheet between the heating member and the pressing member and to fix the toner image to the sheet,
wherein:
the fixing unit includes a coil arranged along an outer surface of the heating member for generating a magnetic field;
a first core fixedly arranged to face the heating member with the coil located therebetween;
a second core which is a bar-shaped body extending along an axial line in a direction orthogonal to a conveying direction of the sheet and formed with a partial cut-off portion when seen in a cross section in an axial direction, is arranged in a magnetic path between the first core and the heating member, when seen in a magnetic field generation direction by the coil, and can change a posture thereof; and
a magnetic adjusting mechanism for changing the posture of the second core between a first posture for guiding a magnetic field by retracting the cut-off portion from the magnetic path and a second posture for increasing magnetic resistance by locating the cut-off portion in the magnetic path by rotating the second core about an axial line thereof.

2. An image forming apparatus according to claim 1, wherein:
the coil generates the magnetic field for induction heating the heating member at least over a first area on the heating member to be held in contact with a maximum one of sheets conveyable by the fixing unit when this sheet passes, and
the cut-off portion of the second core is arranged at a position corresponding to each of the opposite end positions of the first area.

3. An image forming apparatus according to claim 2, wherein the cut-off portions of the second core are substantially arranged at positions outside a second area to be held in contact with a minimum one of sheets conveyable by the fixing unit when this sheet passes.

4. An image forming apparatus according to claim 2, wherein:
the second core is formed such that a central part thereof located in the center when viewed in the axial direction has a substantially circular cross section over a range corresponding to a specified sheet width and the cut-off portions located at the opposite sides of the central part have a substantially half-moon shaped cross section obtained by partly cutting off a circular shape; and
the orientations of the cut-off portions having the substantially half-moon shaped cross section change according to the rotation of the second core about the axial line.

5. An image forming apparatus according to claim 4, further comprising a rotary shaft member for supporting the second core, wherein the second core includes a substantially circular first block and substantially half-moon shaped second blocks and is bonded to the outer circumferential surface of the rotary shaft member.

6. An image forming apparatus according to claim 5, wherein either one or both of the first and second blocks are made up of smaller blocks.

7. An image forming apparatus according to claim 5, wherein the magnetic adjusting mechanism includes a motor for rotating the rotary shaft member.

8. An image forming apparatus according to claim 1, wherein:
the heating member includes an arcuate part;
the first core includes an arch core having an arcuate shape; and
the second core is arranged near the arcuate part of the heating member and one end of the arch core.
